(19) United States
(12) Patent Application Publication
(10) Pub. No.: US 2008/0026349 A1
(43) Pub. Date: Jan. 31, 2008

(54) BEHAVIOR CARD GAME METHOD AND APPARATUS

(76) Inventor: Steven N. Verona, Penn Valley, PA (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/828,834

(22) Filed: Jul. 26, 2007

Related U.S. Application Data
(60) Provisional application No. 60/833,432, filed on Jul. 26, 2006.

(51) Int. Cl. G09B 19/00

(52) U.S. Cl. 434/238

(57) ABSTRACT

A game that teaches learning children rewards for desirable behavior and punishments for undesirable behavior. One or more cards are given to a child or other learning person. The cards have indicia indicating a reward and the number of points required to receive the reward. Points are awarded, and preferably noted on the card, for desirable acts by the child. Finally, upon receiving all of the points required, the child redeems the card for the reward indicated. The invention teaches learners to behave appropriately to receive a reward, and avoid inappropriate behavior to avoid losing a reward.

### CROSS-REFERENCES TO RELATED APPLICATIONS

This application claims the benefit of U.S. Provisional Application No. 60/833,432 filed Jul. 26, 2006.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to a method of improving the behavior of a person or persons, and more particularly a card game used in a method of improving the behavior of a child or group of children.

2. Description of the Related Art

It is well known that children need to be taught acceptable behavior in different circumstances, but that children often do not respond well to the lecture method of teaching. On the other hand, children enjoy games, especially those with clearly defined rules that they can understand. Therefore, there is a need for a behavior-teaching game that children enjoy.

### BRIEF SUMMARY OF THE INVENTION

It is an object of an exemplary embodiment of the present invention to provide a method of encouraging desirable behavior in a learning person, such as a child or adult with behavioral problems. The method comprises the step of a first person giving at least one card to the learning person. The card bears at least one indicium of a reward and the card contains at least one indicium of the number of points required for receiving the reward. In a preferred embodiment, the indicium of the reward is text and/or graphics, and the indicium of the number of points required is text. The first person awards at least one point for desirable behavior by the learning person, such as cleaning up his or her room. The number of points is not critical, but the progress toward the reward is important. A plurality of points, awarded for desirable behavior, is summed, such as by the first person. The first person awards to the learning person the reward represented by said at least one indicium when the sum of the plurality of points is at least as great as said at least one indicium of the number of points required. Thus, when the learning person earns the prescribed number of points, he receives the reward indicated by the indicium on the card.

In a preferred embodiment, the first person, who is preferably a parent or guardian, indicates the awarded points on the card, such as by writing indicia in a predetermined region of the card, by stamping indicia in the predetermined region or by punching a hole in the predetermined region. Preferably, the learning person turns the card over to the first person when the reward is given. Most preferably, there are indicia on the card indicating positive awards for good behavior and negative awards for bad behavior.

Thus, using the method, a parent can encourage the desirable behavior and discourage the negative behavior. Additionally, the method provides flexibility for the parent to tailor the method to the particular desires and personality traits of the child.

### BRIEF DESCRIPTION OF THE SEVERAL VIEWS OF THE DRAWINGS

FIG. 1 is a front view illustrating a preferred card used in an embodiment of the present invention.

FIG. 2 is a rear view illustrating a preferred card used in an embodiment of the present invention.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents that operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

The invention uses cards that can easily be held in the hands of the average child 3 years through 12 years old, as well as the average adult. An acceptable size is the size of conventional playing cards or baseball cards. The cards preferably have the appearance of trading or playing cards, inasmuch as they are similar in size, and preferably have a durable finish and construction. In a preferred embodiment, the cards have pictures, such as drawings, photographs, printed words or other graphical indicia indicating one or more rewards that can be obtained. The cards also have textual indicia printed thereon.

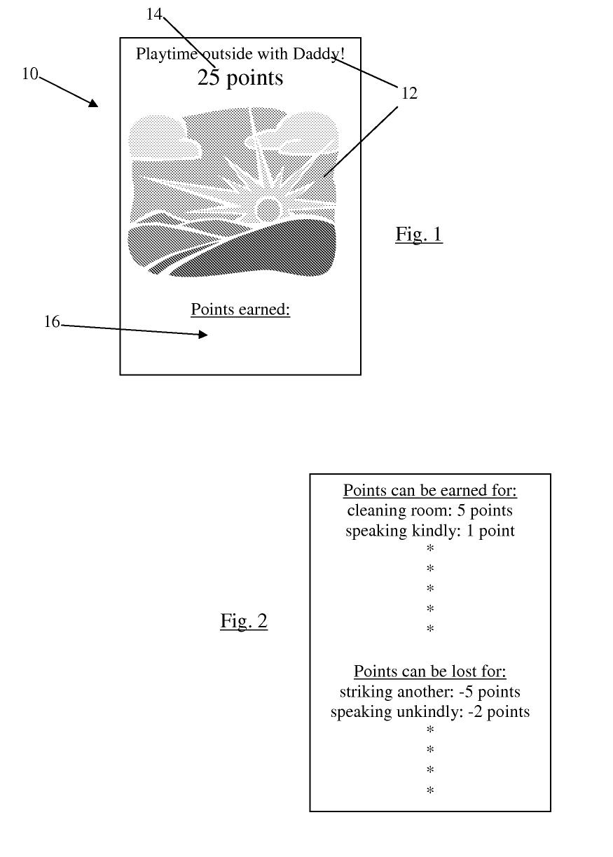

An example is shown in the card 10 of FIG. 1. The card 10 has indicia including the text “playtime outside with daddy”, which indicates to the child that he will, upon attaining the required number of points, receive the sole attention of his father outdoors for a period of time. An alternative reward is “30 minutes on the computer”, in which the child would receive time on the computer for playing games, sending and receiving email, operating educational software, etc. Any positive outcome can be considered a reward. Thus, each card indicates a reward for the child's appropriate behavior. It is contemplated to have punishment cards that show a negative result for undesirable behavior. Such punishment cards are essentially identical to the reward cards shown and described herein, but have negative consequences for points awarded for negative behavior.

As noted above, the card 10 has the reward pictured or described on at least one side using images and/or other indicia, such as the text and graphics 12 shown in FIG. 1. Additionally, each card is assigned a number of points that the child needs to attain in order to receive the reward, and the number of points can be indicated on the card, such as by the indicium 14, or there can be a legend associated with the cards that associates each card with a particular number of points.

During the playing of the game, the parent or guardian initials or otherwise indicates on the card, such as in the region 16 in FIG. 1, that one or more points have been earned for good behavior. This can be accomplished on the card by writing or otherwise indicating that one or more points have been earned. The award of points is indicated on the card immediately after the appropriate behavior in order to reward the child immediately for the desired behavior. When all of the points required for a particular reward have been earned, the child can redeem the card with the parent for the reward pictured and/or described.

In the method of the invention, one or more cards are awarded to one or more children to start the game, or as a result of the child or children engaging in desirable behavior. The parent or guardian determines which step works best for the particular child. For example, if the child picked up her toys without being asked, the father rewards the child with a card that has an illustration of the sun and a heading “Playtime outside with daddy!” In an alternative embodiment, the card or cards are given as an incentive to engage in desirable behavior in exchange for the reward on the card or cards.

In either case, the card or cards communicate that the reward indicated will be given upon the earning of “25 Points”. Of course, any number of points can be assigned to a reward, and the number is not a critical feature of the invention. The critical feature is the clear communication on the card or on a closely related source of information (placard, game box, legend, poster, etc.) of the number of points that are required in order to receive the reward.

Each time the child engages in behavior, which includes positive acts (e.g., cleaning up) and the omission of negative acts (e.g., not spilling food), that the parent wants to reward, one or more points can be given as an incentive. The number of points awarded is not a critical feature of the invention, as this will be determined by the parent or guardian. However the game can include guidelines for the award of points. The number of points should be in proportion to the desirability of the behavior. Therefore, for example, if a child picks up his toys after being instructed to do so by a parent, the number of points should be smaller than if the child did so without prompting.

In the preferred embodiment, the parent notes the award of points on the card itself, such as by writing on the card. Any means by which the number of points is indicated on the card is contemplated, including, but not limited to, writing, stamping, tearing off a portion of the card, and punching the card with a unique hole punch.

In one embodiment, the backs of the cards feature suggested good behavior to teach the children manners, respect, obedience, etc. For example, the back of the card 10, shown in FIG. 2, contains a list of good behavior awards and bad behavior awards. The method teaches children that they are rewarded for good behavior and punished for bad behavior. It also teaches them that some things, such as the promised rewards, are worth saving for by behaving well over a long period of time to earn points toward an eventual reward.

The first step in the method is the provision of one or more cards to a child. The cards have indicia indicating a reward and the number of points required to receive the reward. The second step is the awarding of points, noted by marking on the card, for desirable acts by the child. These acts result in one or more points toward the reward. Finally, upon receiving all of the points required, the child redeems the card for the reward indicated.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of encouraging desirable behavior in a learning person, the method comprising the steps of:
(a) a first person giving at least one card to the learning person, said at least one card bearing at least one indicium of a reward and said at least one card containing at least one indicium of the number of points required for receiving the reward;
(b) the first person awarding at least one point for desirable behavior by the learning person;
(c) summing a plurality of points; and
(d) the first person awarding to the learning person the reward represented by said at least one indicium when the sum of the plurality of points is at least as great as said at least one indicium of the number of points required.

2. The method in accordance with claim 1, further comprising the step of indicating on said at least one card said at least one point awarded.

3. The method in accordance with claim 2, wherein the step of indicating on said at least one card further comprises writing indicia on said at least one card in a predetermined region.

4. The method in accordance with claim 2, wherein the step of indicating on said at least one card further comprises stamping indicia on said at least one card in a predetermined region.

5. The method in accordance with claim 2, wherein the step of indicating on said at least one card further comprises punching a hole in said at least one card in a predetermined region.

6. The method in accordance with claim 1, further comprising the step of the learning person turning said at least one card over to the first person when the sum of the plurality of points is at least as great as said at least one indicium of the number of points required.

7. The method in accordance with claim 1, further comprising the step of the learning person engaging in desirable behavior.

8. The method in accordance with claim 1, further comprising indicating on said at least one card positive awards for good behavior and negative awards for bad behavior.
